(19) United States
(12) Patent Application Publication
(10) Pub. No.: US 2015/0048732 A1
(43) Pub. Date: Feb. 19, 2015

(54) RANGE LIMITED LATCH

(71) Applicant: Waterloo Industries, Inc., Oak Creek, WI (US)

(72) Inventors: Sergio Herrera Gutierrez, Nogales (MX); Jiju Johnson, Milwaukee, WI (US)

(21) Appl. No.: 14/457,547

(22) Filed: Aug. 12, 2014

Related U.S. Application Data
(60) Provisional application No. 61/865,249, filed on Aug. 13, 2013.

(51) Int. Cl. E05B 65/44; A47B 88/04; A47B 96/00; E05C 3/12

(52) U.S. Cl. CPC E05B 65/44; E05C 3/12; A47B 88/04; A47B 96/00
USPC 312/333; 292/336.3

(57) ABSTRACT

A latch mechanism includes a latchable structure and a latch member assembled with the latchable structure and movable between a latching position and a releasing position. The latch member includes a first stop portion positioned to engage a second stop portion carried by the latchable structure when the latch member is in one of the latching position and the releasing position.

### CROSS-REFERENCE TO RELATED APPLICATION

This application claims priority to and the benefit of U.S. Provisional Patent Application Ser. No. 61/865,249, entitled “RANGE LIMITED LATCH” and filed Aug. 13, 2013, the entire disclosure of which is incorporated herein by reference.

### BACKGROUND

Cabinets, such as, for example, mechanics' cabinets and tool cabinets are commonly fabricated from sheet metal and may include a cabinet enclosure with one or more hinged doors and/or sliding drawers to provide access to the contents of the cabinet. In order to provide security for the contents within the cabinet, a locking system may be provided. The locking system will normally include a key actuated mechanism which enables locking of a door or drawer in a closed position. Actuation or release of the key operated mechanism is necessary in order to release or unlock the doors or drawers. Additionally or alternatively, a cabinet may be provided with a release latch for retaining an unlocked drawer or door in a closed position against inadvertent opening of the drawer or door (e.g., due to bumping, jostling, or tipping of the cabinet). User manipulation of a release member (e.g., a lever, knob, button, slideable or pivotable handle, or other such mechanism) moves the release latch to a drawer or door releasing position to allow the drawer or door to open.

### SUMMARY

According to an exemplary embodiment of the present application, a latch mechanism includes a latchable structure and a latch member assembled with the latchable structure and movable between a latching position and a releasing position. The latch member includes a first stop portion positioned to engage a second stop portion carried by the latchable structure when the latch member is in one of the latching position and the releasing position.

In another exemplary embodiment, a drawer includes a drawer enclosure including a front wall and a side wall, and a latch member assembled with the drawer enclosure and pivotable between a latching position and a releasing position. The latch member includes a first stop portion positioned to engage a second stop portion carried by the drawer enclosure when the latch member is in one of the latching position and the releasing position.

In still another exemplary embodiment, a cabinet includes a cabinet enclosure defining an internal cavity and a drawer assembled with the cabinet enclosure and slideable from a closed position disposed within the internal cavity to an open position. The drawer includes a drawer enclosure including a front wall and a side wall, and a latch member assembled with the drawer enclosure and pivotable between a latching position in which an interlocking end of the latch member interlocks with a strike plate of the cabinet enclosure, and a releasing position in which the interlocking end of the latch member disengages from the strike plate to permit movement of the drawer to the open position. The latch member includes a first stop portion positioned to engage a second stop portion carried by the drawer enclosure when the latch member is in one of the latching position and the releasing position.

### BRIEF DESCRIPTION OF THE DRAWINGS

Further features and advantages of the invention will become apparent from the following detailed description made with reference to the accompanying drawings, wherein:

FIG. 1A illustrates a schematic view of a range limited latch mechanism, in accordance with an exemplary embodiment;

FIG. 1B illustrates a schematic view of a range limited latch mechanism, in accordance with another exemplary embodiment;

FIG. 1C illustrates a schematic view of a range limited latch mechanism, in accordance with another exemplary embodiment;

FIG. 1D illustrates a schematic view of a range limited latch mechanism, in accordance with another exemplary embodiment;

FIG. 1E illustrates a schematic view of a range limited latch mechanism, in accordance with another exemplary embodiment;

FIG. 2 illustrates a perspective view of a cabinet drawer including a range limited latch mechanism, in accordance with another exemplary embodiment;

FIG. 3 illustrates an enlarged perspective view of the latch mechanism of FIG. 2;

FIG. 4 illustrates a side view of the latch mechanism of FIG. 2, shown in a first limit position;

FIG. 5 illustrates a side view of the latch mechanism of FIG. 2, shown in a second limit position;

FIG. 6 illustrates a perspective view of a range limited latch mechanism, in accordance with another exemplary embodiment;

FIG. 7 illustrates a perspective view of a range limited latch mechanism, in accordance with another exemplary embodiment;

FIG. 8 illustrates a perspective view of a range limited latch mechanism, in accordance with still another exemplary embodiment;

FIG. 9 illustrates a perspective view of a range limited latch mechanism, in accordance with yet another exemplary embodiment;

FIG. 10 illustrates a perspective view of a range limited latch mechanism, in accordance with another exemplary embodiment;

FIG. 11 illustrates a perspective view of a range limited latch mechanism, in accordance with another exemplary embodiment;

FIG. 12 illustrates a side view of the latch mechanism of FIG. 11, shown in a first limit position;

FIG. 13 illustrates a side view of the latch mechanism of FIG. 11, shown in a second limit position; and

FIG. 14 illustrates a perspective view of a range limited latch mechanism, in accordance with another exemplary embodiment, with the drawer handle shown in broken lines to illustrate additional features of the mechanism.

### DETAILED DESCRIPTION

The Detailed Description merely describes exemplary embodiments and is not intended to limit the scope of the claims in any way. Indeed, the invention as claimed and described is broader than and unlimited by the exemplary embodiments, and the terms used in the claims have their full ordinary meaning.

A cabinet release latch mechanism may include a pivotable latch member with a latching or interlocking portion that interlocks with a strike member (e.g., an apertured plate or flange) to retain a drawer or door in a closed position. In one embodiment, the pivotable latch member is assembled with, disposed on, or otherwise carried by a drawer or door of the cabinet, and the strike member is assembled with, disposed on, or otherwise carried by an enclosure of the cabinet. In another embodiment, the pivotable latch member is carried by the cabinet enclosure and the strike member is carried by the drawer or door. The pivotable latch member may be biased (e.g., by a spring, gravitational biasing, component flexure) toward the interlocking position, such that user operation of the latch member (e.g., by manipulation of a handle or other interface) is required to pivot the latch member out of interlocking engagement with the strike member to allow the drawer or door to be opened. Examples of pivoting drawer latch mechanisms are described in U.S. Pat. No. 6,375,235 and U.S. Patent Application Pub. No. 2008/0150407, and examples of pivoting door latch mechanism are described in U.S. Pat. No. 8,240,786, the entire disclosures of each of which are incorporated herein by reference.

The present application describes arrangements for limiting a range of movement of a pivotable latch member, for example, to provide a positive stop for the latch member in at least one of an interlocking or latching position and a releasing position, to prevent over-rotation of the latch member, and/or to prevent marring or galling damage between the latch member and the strike member. According to an aspect of the present application, a pivotable latch member may be provided with one or more stop portions positioned to engage one or more stop portions to limit a range of movement of the latch member. In one such embodiment, the pivotable latch member is assembled with a latchable structure (e.g., a drawer, door, or cabinet enclosure) and is provided with one or more stop portions positioned to engage one or more stop portions carried by the latchable structure. Many different types of stop portions may be utilized for range limiting engagement between a pivotable latch and a latchable structure, including, for example, pins, fasteners, tabs, flanges, blocks, cutouts, slots, and notches.

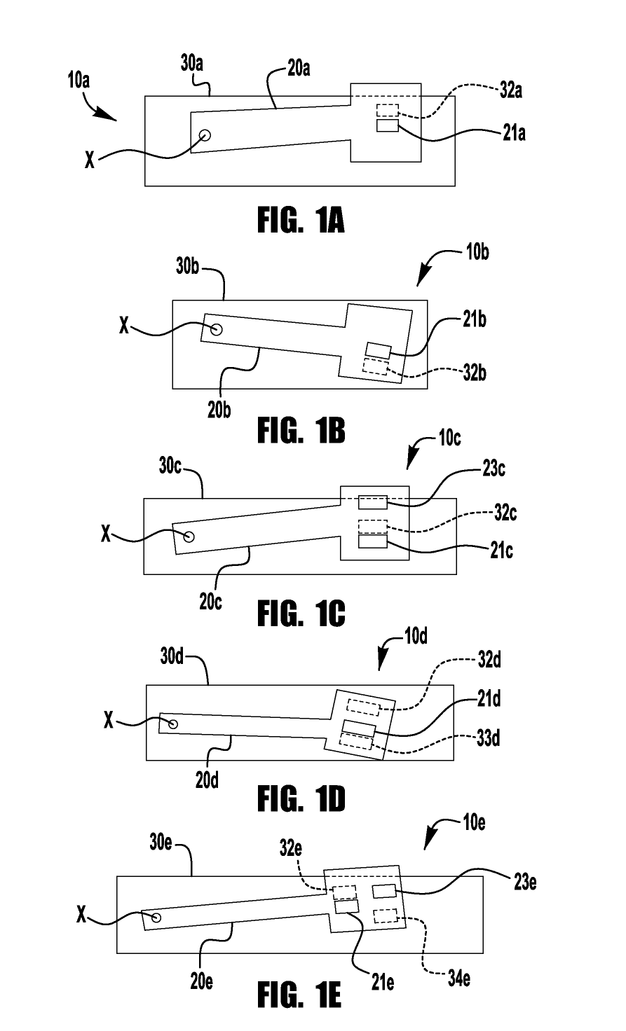

In an exemplary latch mechanism 10a, as schematically shown in FIG. 1A, a latch member 20a is assembled with a latchable structure 30a and is pivotable about a longitudinal axis X between a latching position and a releasing position. The latch member 20a includes a first longitudinally extending stop portion 21a positioned to engage a second longitudinally extending stop portion 32a carried by the latchable structure 30a when the latch member 20a is in the latching position.

In another exemplary latch mechanism 10b, as schematically shown in FIG. 1B, a latch member 20b is assembled with a latchable structure 30b and is pivotable about a longitudinal axis X between a latching position and a releasing position. The latch member 20b includes a first longitudinally extending stop portion 21b positioned to engage a second longitudinally extending stop portion 32b carried by the latchable structure 30b when the latch member 20b is in the releasing position.

In still another exemplary latch mechanism 10c, as schematically shown in FIG. 1C, a latch member 20c is assembled with a latchable structure 30c and is pivotable about a longitudinal axis X between a latching position and a releasing position. The latch member 20c includes a first longitudinally extending stop portion 21c positioned to engage a second longitudinally extending stop portion 32c carried by the latchable structure 30c when the latch member 20c is in the latching position, and a third longitudinally extending stop portion 23c positioned to engage the second longitudinally extending stop portion 32c when the latch member 20c is in the latching position.

In yet another exemplary latch mechanism 10d, as schematically shown in FIG. 1D, a latch member 20d is assembled with a latchable structure 30d and is pivotable about a longitudinal axis X between a latching position and a releasing position. The latch member 20d includes a first longitudinally extending stop portion 21d positioned to engage a second longitudinally extending stop portion 32d carried by the latchable structure 30d when the latch member 20d is in the latching position, and positioned to engage a third longitudinally extending stop portion 33d carried by the latchable structure 30d when the latch member 20d is in the latching position.

In another exemplary latch mechanism 10e, as schematically shown in FIG. 1E, a latch member 20e is assembled with a latchable structure 30e and is pivotable about a longitudinal axis X between a latching position and a releasing position. The latch member 20e includes a first longitudinally extending stop portion 21e positioned to engage a second longitudinally extending stop portion 32e carried by the latchable structure 30e when the latch member 20e is in the latching position, and a third longitudinally extending stop portion 23e positioned to engage a fourth longitudinally extending stop portion 34e carried by the latchable structure 30e when the latch member 20e is in the latching position.

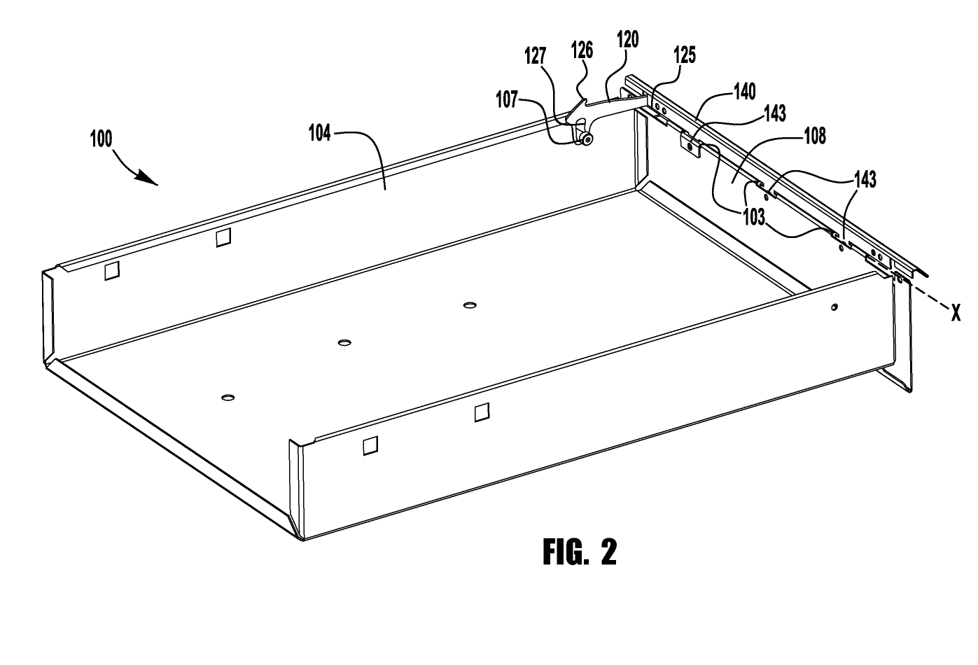

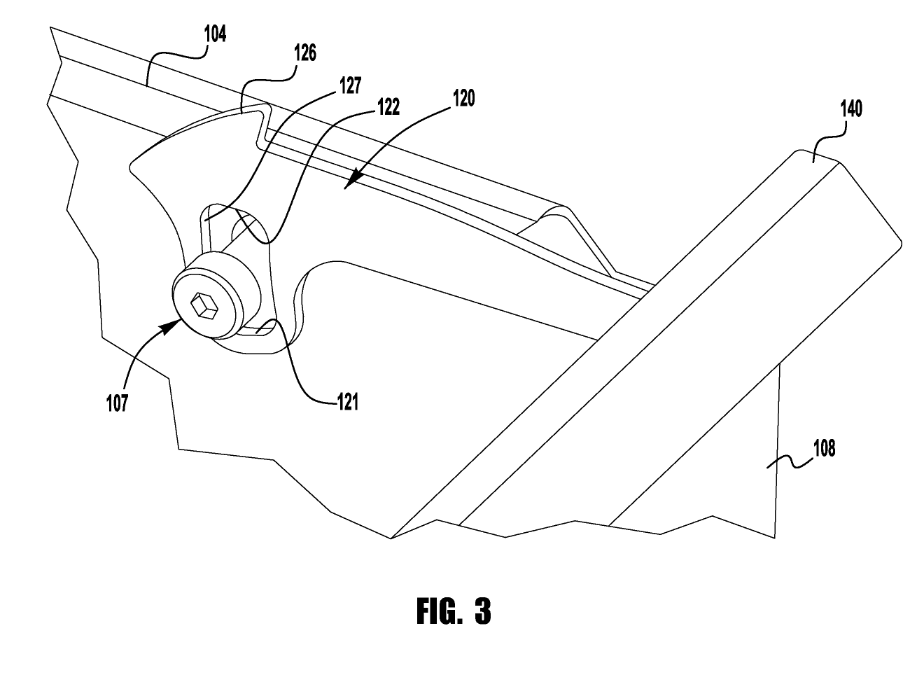

In an exemplary embodiment, as shown in FIGS. 2-5, a cabinet drawer 100, having a front wall 108, first and second side walls 104, a bottom wall, and a rear wall (not shown), includes a pivotable latch member 120 attached to (e.g., integral to or assembled with) a user operable drawer release handle 140. The drawer release handle 140 is pivotably mounted to the front wall 108 of the drawer enclosure, for example, by tabs 143 received in slots 103 in the front wall 108, such that the handle 140 and latch member 120 are pivotable about a longitudinal axis X defined by the pivotable attachment of the handle 140 to the front wall 108.

The exemplary latch member 120 includes a flange end 125 secured to the release handle 140 (e.g., by fasteners) and an interlocking end or tang 126 shaped and positioned to engage a strike member secured to the cabinet enclosure (e.g., an apertured strike plate, as shown in the above-incorporated U.S. Pat. No. 6,375,235 and U.S. Patent Application Pub. No. 2008/0150407). Pivoting movement of the release handle 140 pivots the latch member 120 to disengage the tang 126 from the strike member, thereby permitting withdrawal of the drawer 100 from a cavity defined by the cabinet enclosure.

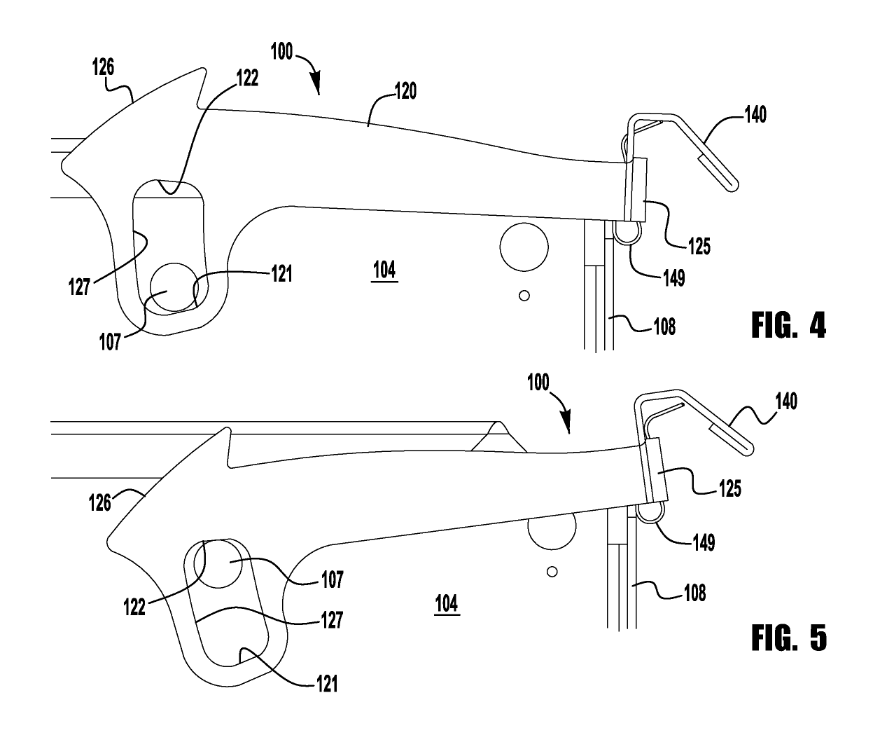

To limit pivoting movement of the latch member 120, a stop pin 107 is assembled with a side wall 104 of the drawer 100, and extends through a slot 127 in the latch member 120. As shown, the stop pin 107 may be positioned such that the stop pin 107 engages a first end portion or stop portion 121 of the slot 127 when the latch member 120 is in the interlocking position (see FIG. 4). Additionally or alternatively, the stop pin 107 may be positioned such that the stop pin 107 engages a second end portion or stop portion 122 of the slot 127 when the latch member 120 is in the releasing position (see FIG. 5).

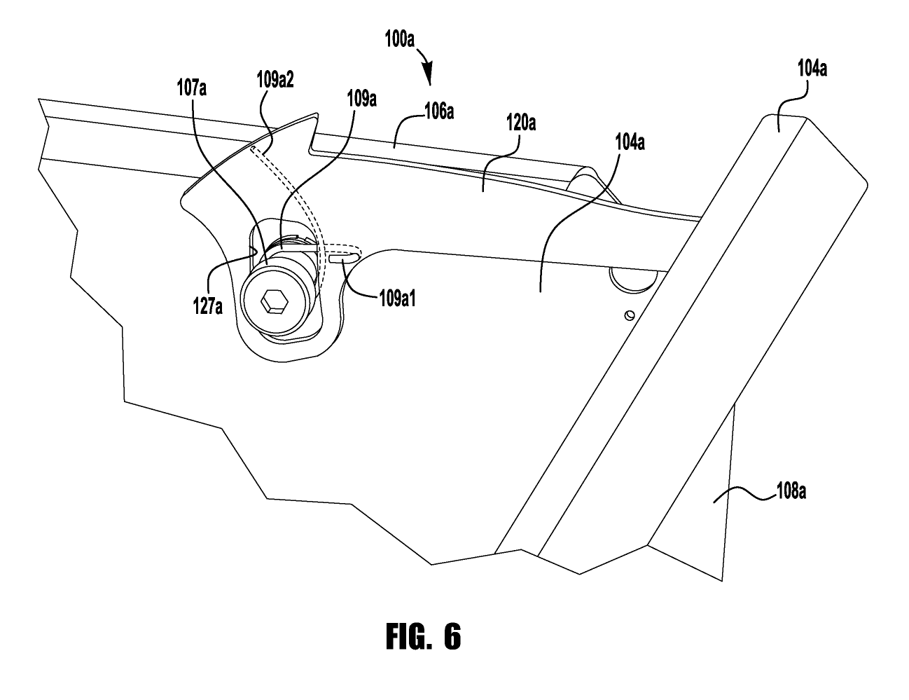

The latch mechanism may include a biasing spring or other biasing component configured to bias the latch member and operatively connected handle toward the latched or interlocking position. In the illustrated embodiment, as evident in FIGS. 4 and 5, a leaf spring 149 assembled between the handle 140 and the drawer front wall 108 applies a biasing force to the handle 140 to bias the handle 140 (and with it, the latch member 120) toward the interlocking position. In another embodiment, as shown in FIG. 6, a cabinet drawer 100a may additionally or alternatively include a spring (e.g., a torsion spring) 109a assembled between the stop pin 107a and the drawer side wall 104a to bias the latch member 120a (and with it, the handle 140a) toward the interlocking position. In the illustrated embodiment, the spring 109a is coiled around the stop pin 107a, with a first end 109a1 anchored in a hole in the latch member 120a, and a second end 109a2 retained within a folded upper flange 106a of the drawer side wall 104a

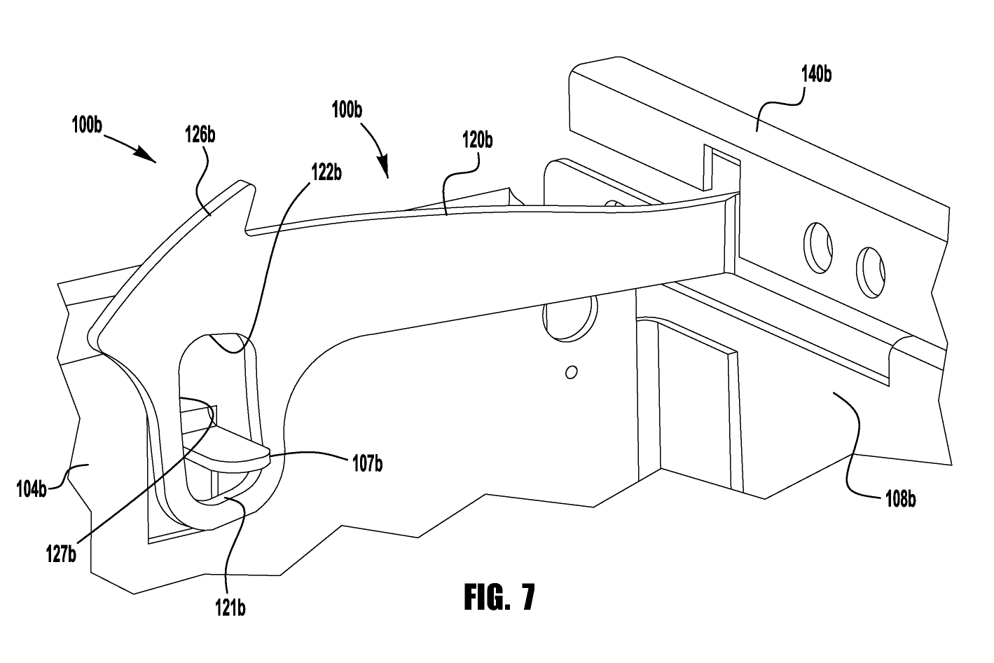

Other types of stopping portions and stopping engagement of a latch member may additionally or alternatively be utilized. For example, as shown in FIG. 7, the cabinet side wall 104b may be provided with an integral bent tab 107b that extends through a slot 127b in the latch member 120b. The tab 107b may be positioned such that the tab engages a first end portion or stop portion 121b of the slot 127b when the latch member 120b is in the interlocking position. Additionally or alternatively, the tab 107b may be positioned such that the tab engages a second end portion or stop portion 122b of the slot 127b when the latch member 120b is in the releasing position.

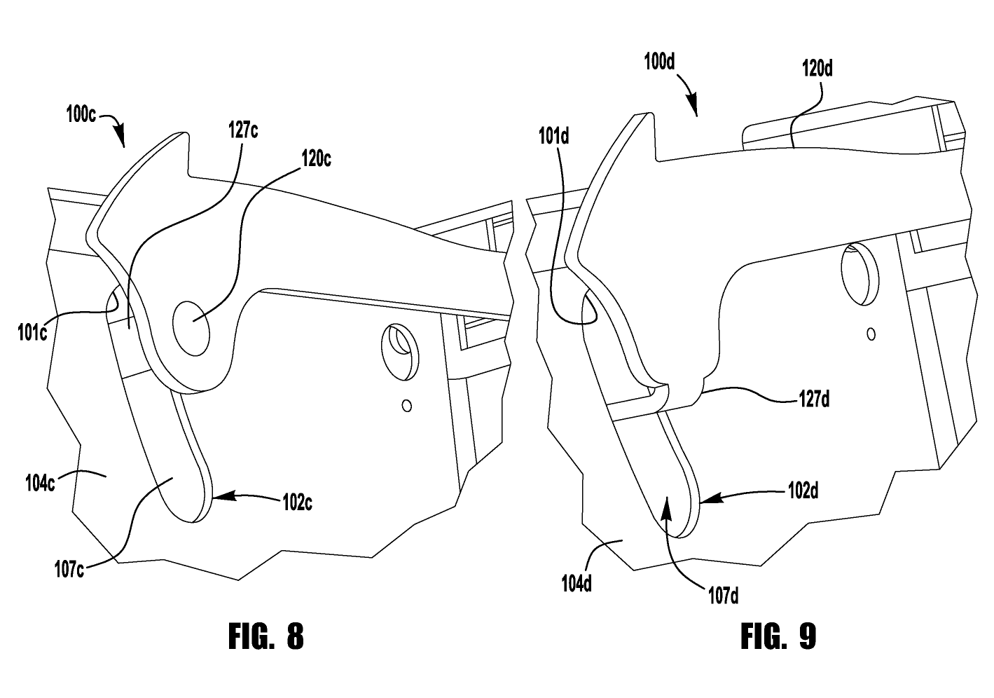

In another exemplary embodiment, as shown in FIG. 8, the latch member 120c may be provided with a stop pin 127c that extends through a slot 107c in the cabinet side wall 104c. The stop pin 127c may be positioned such that the stop pin engages a first end portion or stop portion 101c of the slot 107c when the latch member 120b is in the interlocking position. Additionally or alternatively, the stop pin 127c may be positioned such that the stop pin engages a second end portion or stop portion 102c of the slot 107c when the latch member 120c is in the releasing position.

In another exemplary embodiment, as shown in FIG. 9, the latch member 120d may be provided with an integral bent tab 127d that extends through a slot 107d in the cabinet side wall 104d. The tab 127d may be positioned such that the tab engages a first end portion or stop portion 101d of the slot 107d when the latch member 120d is in the interlocking position. Additionally or alternatively, the tab 127d may be positioned such that the tab engages a second end portion or stop portion 102d of the slot 107d when the latch member 120d is in the releasing position.

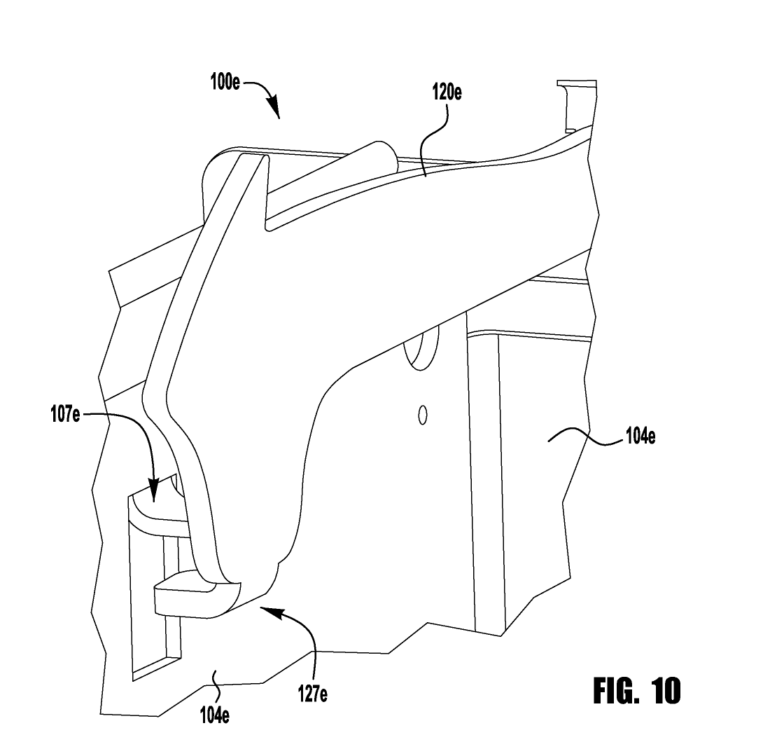

In still another exemplary embodiment, as shown in FIG. 10, the latch member 120e may be provided with an integral bent tab 127e positioned to engage an integral bent tab 107e disposed on the cabinet side wall 104e when the latch member 120e is in the interlocking position. Additionally or alternatively (not shown), a similar integral bent tab may be provided on the latch member for engagement with a bent tab on the cabinet side wall when the latch member is in the releasing position.

According to another aspect of the present application, a range limited latch member may be pivotally connected directly to the same wall or other structural element on which a latch engaging stop portion is disposed. In such an arrangement, the latch member may remain detached from a user operable handle or other interface, for example, to facilitate assembly of the cabinet drawer, or to reduce the number of manufacturing tolerances that can affect the consistent performance of the latch.

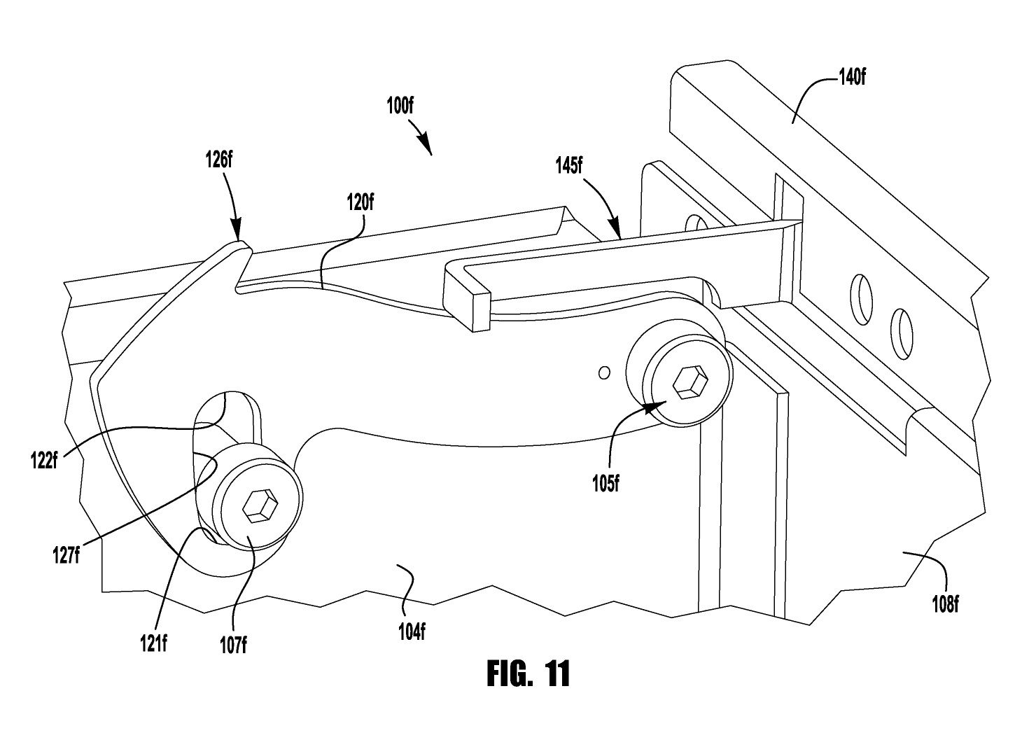

In one embodiment, a latch member may be pivotably mounted to a cabinet drawer side wall defining a latch engaging side portion. In the illustrated embodiment of FIGS. 11-13, a cabinet drawer 100f includes a pivotable latch member 120f having a first end 125f pivotably attached to a cabinet drawer side wall 104f by a mounted pivot pin 105f (e.g., a threaded fastener) installed through a hole in the latch member 120f. The exemplary latch member 120f includes an interlocking end or tang 126f shaped and positioned to engage a strike member secured to the cabinet enclosure.

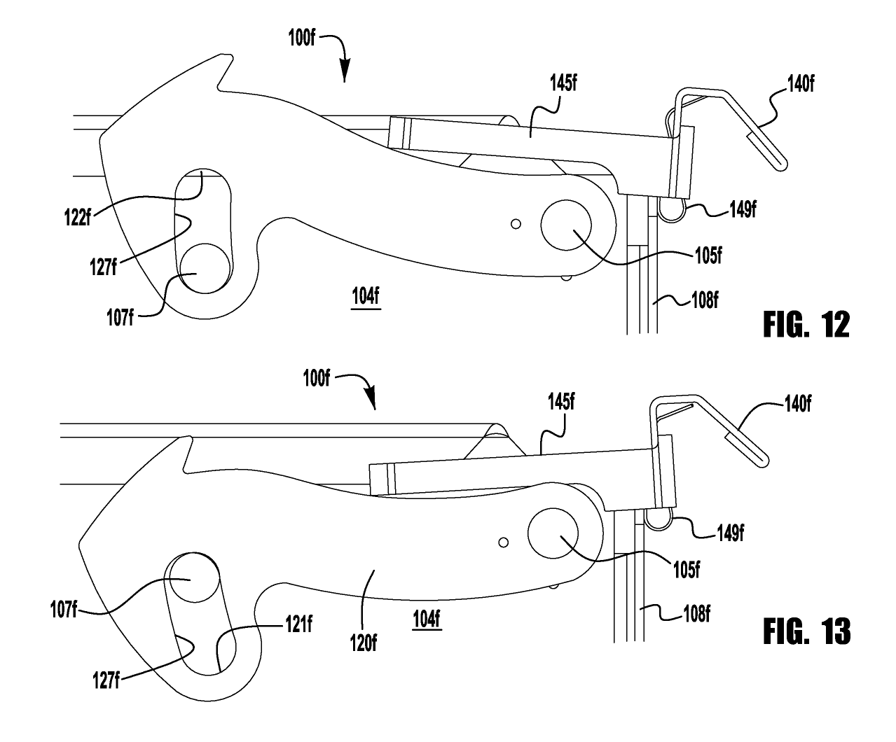

To limit pivoting movement of the latch member 120f, a stop pin 107f is assembled with the side wall 104f of the drawer 100f, and extends through a slot 127f in the latch member 120f. As shown, the stop pin 107f may be positioned such that the stop pin 107f engages a first end portion or stop portion 121f of the slot 127f when the latch member 120f is in the interlocking position (see FIG. 12). Additionally or alternatively, the stop pin 107f may be positioned such that the stop pin 107f engages a second end portion or stop portion 122f of the slot 127f when the latch member 120f is in the releasing position (see FIG. 13). Other types of stopping portions and stopping engagement of a latch member may additionally or alternatively be utilized, as shown, for example, in the exemplary embodiments of FIGS. 7-10.

A drawer release handle 140f is pivotably mounted to a front wall 108f of the drawer 100f, for example, by tabs received in slots in the front wall (similar to the embodiment of FIGS. 2-5), such that the handle 140f is pivotable about a longitudinal axis X defined by the pivotable attachment of the handle 140f to the front wall 108f. To operatively connect the drawer release handle 140f to the latch member 120f, the drawer release handle 140f is provided with a latch engaging projection 145f that extends above and proximate to the latch member 120f, such that pivoting movement of the release handle 140f causes the projection 145f to engage an upper edge of the latch member 120f, pivoting the latch member to disengage the tang 126f from the strike member, thereby permitting withdrawal of the drawer 100f from the cabinet enclosure. Other latch engaging arrangements may additionally or alternatively be utilized, including, for example, a pushbutton operated projection that engages an upper edge of the latch.

The latch mechanism may include one or more biasing springs or other biasing components configured to bias one or both of the latch member and operatively connected handle toward the latched or interlocking position. In the illustrated embodiment, as evident in FIGS. 12 and 13, a leaf spring 149f assembled between the handle 140f and the drawer front wall 108f applies a biasing force to the handle 140f to bias the handle 140f toward the interlocking position. Also, similar to the embodiment of FIG. 6, the cabinet drawer may additionally or alternatively include a spring (e.g., a torsion spring) assembled between the stop pin and the drawer side wall to bias the latch member (and with it, the handle) toward the interlocking position.

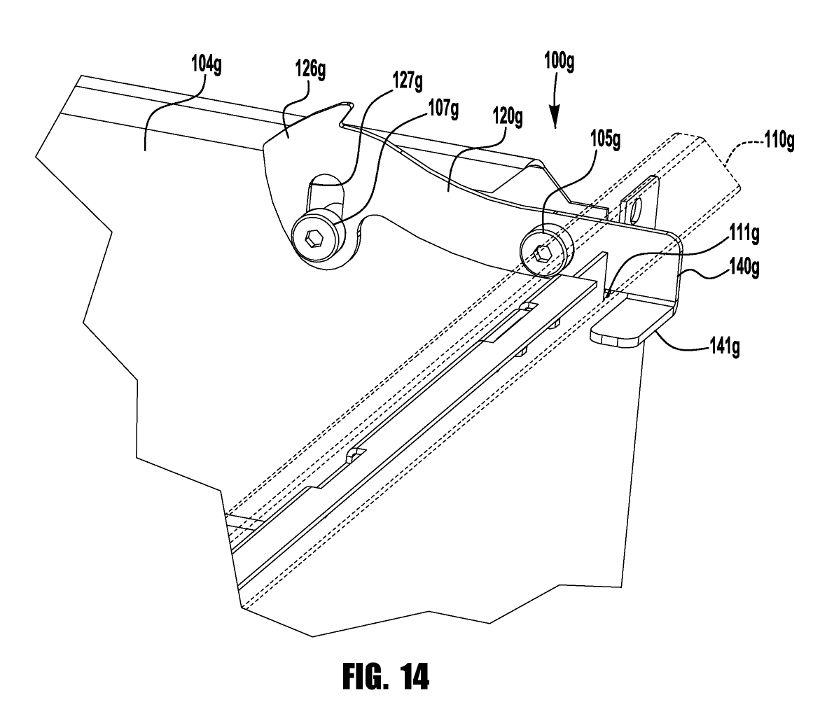

In another exemplary embodiment, a range limited latch member that is pivotably connected to a latchable structure may be directly connected to (e.g., assembled with or integral to) a user operable release member spaced apart from the latch member pivot axis. In the illustrated embodiment of FIG. 14, a cabinet drawer 100g includes a pivotable latch member 120g pivotably attached to a cabinet drawer side wall 104g by a mounted pivot pin 105g (e.g., a threaded fastener) installed through a hole in the latch member 120g. The exemplary latch member 120g includes an interlocking end or tang 126g shaped and positioned to engage a strike member secured to the cabinet enclosure.

Similar to the embodiment of FIGS. 11-13, a stop pin 107g is assembled with the side wall 104g of the drawer 100g, extending through a slot 127g in the latch member 120g, to limit pivoting movement of the latch member 120g. Other types of stopping portions and stopping engagement of a latch member may additionally or alternatively be utilized, as shown, for example, in the exemplary embodiments of FIGS. 7-10.

The exemplary latch member is provided with a drawer release member 140g extending outward of the pivot pin 105g (opposite the interlocking end 126g) through a slot 111g in the front wall 108g of the drawer 100g below a fixed drawer handle 110g, such that the release member 140g is operable to pivot the latch member 120g about pivot pin 105g. The drawer release member 140g may include a bent tab 141g or other user engageable portion to facilitate pivoting movement of the latch member 120g. As described above, the latch mechanism may include one or more biasing springs or other biasing components configured to bias the latch member and release member toward the latched or interlocking position.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A latch mechanism comprising:
a latchable structure; and
a latch member assembled with the latchable structure and movable between a latching position and a releasing position;
wherein the latch member includes a first stop portion positioned to engage a second stop portion carried by the latchable structure when the latch member is in one of the latching position and the releasing position.

2. The latch mechanism of claim 1, wherein the latchable structure comprises one of a drawer and a door.

3. The latch mechanism of claim 1, wherein the latch member is pivotable about a longitudinal axis between the latching position and the releasing position.

4. The latch mechanism of claim 1, wherein the first stop portion is positioned to engage the second stop portion when the latch member is the latching position.

5. The latch mechanism of any of claim 1, wherein the first stop portion is positioned to engage the second stop portion when the latch member is the releasing position.

6. The latch mechanism of any of claim 1, wherein one of the first and second stop portions comprises an edge of a slot and the other of the first and second stop portions comprises a projection extending through the slot.

7. The latch mechanism of claim 6, wherein the projection comprises at least one of a pin, a fastener, and a bent tab.

8. The latch mechanism of claim 1, wherein the latch member further comprises a third stop portion, wherein the third stop portion is positioned to engage the second stop portion when the latch member is in the other of the latching position and the releasing position.

9. The latch mechanism of claim 8, wherein the first and third stop portions comprise first and second opposed edges of a slot disposed in the latch member and the second stop portion comprises a projection extending through the slot.

10. The latch mechanism of claim 1, wherein the latch member further comprises a third stop portion and the latchable structure further comprises a fourth stop portion, wherein the third stop portion is positioned to engage the fourth stop portion when the latch member is in the other of the latching position and the releasing position.

11. The latch mechanism of claim 1, further comprising a spring member that biases the latch member toward the latching position.

12. The latch mechanism of claim 11, wherein the spring member is assembled with the second stop portion.

13. The latch mechanism of claim 1, further comprising a user operable release member assembled with the latchable structure and operable to move the latch member to the releasing position.

14. The latch mechanism of claim 13, wherein the user operable release member is attached to the latch member.

15. The latch mechanism of claim 13, wherein the user operable release member is integral with the latch member.

16. The latch mechanism of claim 1, wherein the latch member is pivotably secured to the latchable structure by a pivot pin.

17. The latch mechanism of claim 16, wherein the second stop portion comprises a stop pin assembled with the latchable structure, wherein the stop pin extends substantially parallel to the pivot pin.

18. A drawer comprising:
a drawer enclosure including a front wall and a side wall; and
a latch member assembled with the drawer enclosure and pivotable between a latching position and a releasing position;
wherein the latch member includes a first stop portion positioned to engage a second stop portion carried by the drawer enclosure when the latch member is in one of the latching position and the releasing position.

19. The drawer of claim 18, further comprising a drawer release handle assembled with the front wall of the drawer enclosure, the drawer release handle being operable to pivot the latch member to the releasing position.

20. The drawer of claim 19, wherein the latch member is secured to the drawer release handle for pivotable movement therewith.

21. The drawer of claim 19, wherein the latch member is detached from the drawer release handle.

22. The drawer of claim 18, wherein the latch member is pivotably secured to the side wall.

23. The drawer of claim 18, wherein the latch member is pivotably secured to the side wall by a pivot pin.

24. A cabinet comprising:
a cabinet enclosure defining an internal cavity; and
a drawer assembled with the cabinet enclosure and slideable from a closed position disposed within the internal cavity to an open position, the drawer comprising:
a drawer enclosure including a front wall and a side wall; and
a latch member assembled with the drawer enclosure and pivotable between a latching position in which an interlocking end of the latch member interlocks with a strike plate of the cabinet enclosure, and a releasing position in which the interlocking end of the latch member disengages from the strike plate to permit movement of the drawer to the open position;
wherein the latch member includes a first stop portion positioned to engage a second stop portion carried by the drawer enclosure when the latch member is in one of the latching position and the releasing position.
